(19) United States
(12) Patent Application Publication
(10) Pub. No.: US 2026/0254964 A1
(43) Pub. Date: Aug. 27, 2026

(54) UPDATE PARAMETER DETERMINATION FOR SINGLE AND MULTI-HYPOTHESIS PROBABILITY ESTIMATION

(71) Applicant: GOOGLE LLC, Mountain View, CA (US)

(72) Inventors: Jingning Han, Santa Clara, CA (US); Cheng Chen, Milpitas, CA (US); Yaowu Xu, Saratoga, CA (US)

(21) Appl. No.: 19/444,693

(22) Filed: Jan. 9, 2026

Related U.S. Application Data
(60) Provisional application No. 63/762,268, filed on Feb. 24, 2025.

(51) Int. Cl. H04N 19/13; G06N 20/00

(52) U.S. Cl. CPC H04N 19/13; G06N 20/00

(57) ABSTRACT

An update parameter modifier for a probability model parameter that controls an update function for a probability model for entropy coding the sequence of syntax elements is determined. The probability model parameter is modified using the update parameter modifier to obtain a modified probability model parameter. A symbol for a syntax element of the sequence is entropy coded using the probability model. The probability model is then updated using the update function with the modified probability model parameter.

### CROSS REFERENCE TO RELATED APPLICATION(S)

This application claims the benefit of and priority to U.S. Provisional Patent Application Ser. No. 63/762,268, filed Feb. 24, 2025, the entire disclosure of which is incorporated herein by reference.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including lossy and lossless compression techniques. Lossless compression techniques include entropy coding.

### SUMMARY

Probability estimation is used for entropy coding, particularly with context-based entropy coding for lossless compression. Efficiency of the entropy coding depends on the accuracy of the probability model used for probability estimation, including its update process. Approaches to improve probability estimation, while minimizing complexity, are described herein. The teachings herein describe methods and apparatus for entropy coding a sequence of syntax elements that include regularizing a probability model, using time-variant update rates for single and multi-hypothesis probability models, selectively applying multi-hypothesis estimation to different syntax element types, and determining update parameters.

One aspect of the disclosed implementations relates to a method for entropy coding a sequence of syntax elements. The method includes determining an update parameter modifier for a probability model parameter that controls an update function for a probability model for entropy coding the sequence of syntax elements; modifying the probability model parameter using the update parameter modifier to obtain a modified probability model parameter; entropy coding a symbol for a syntax element of the sequence using the probability model; and updating the probability model using the update function with the modified probability model parameter.

One aspect of the disclosed implementations relates to a device that includes a processor. The processor configured to execute instructions to determine an update parameter modifier for a probability model parameter that controls an update function for a probability model for entropy coding a sequence of syntax elements; modify the probability model parameter using the update parameter modifier to obtain a modified probability model parameter; entropy code a symbol for a syntax element of the sequence using the probability model; and update the probability model using the update function with the modified probability model parameter.

One aspect of the disclosed implementations relates to a non-transitory computer-readable storage medium including instructions that, when executed by a processor, perform operations for entropy coding a sequence of syntax elements. The operations include determining an update parameter modifier for a probability model parameter that controls an update function for a probability model for entropy coding the sequence of syntax elements; modifying the probability model parameter using the update parameter modifier to obtain a modified probability model parameter; entropy coding a symbol for a syntax element of the sequence using the probability model; and updating the probability model using the update function with the modified probability model parameter.

One aspect of the disclosed implementations relates to a compressed bitstream stored on a non-transitory computer-readable medium. The compressed bitstream includes a header portion and a data portion. The header portion includes an identifier for a first update parameter modifier that is used to modify a probability model parameter governing an update function for a probability model. The data portion includes symbols for syntax elements that are entropy coded using the probability model. During decoding, the probability model is updated after decoding a symbol using the update function with the probability model parameter as modified by the first update parameter modifier.

Variations in these aspects and other aspects of this disclosure are disclosed in the following detailed description of the implementations, the appended claims, and the accompanying figures.

### BRIEF DESCRIPTION OF THE DRAWINGS

The description herein refers to the accompanying drawings described below, wherein like reference numerals refer to like parts throughout the several views.

FIG. 1 is a schematic of an example of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an example of an encoder.

FIG. 5 is a block diagram of an example of a decoder.

FIG. 6 is a flow chart of a technique for entropy coding a sequence of syntax elements according to the teachings herein.

FIG. 7 is a diagram illustrating some syntax elements associated with quantized transform coefficients according to implementations of this disclosure.

FIG. 8 is a flow chart of a technique for regularizing a probability model according to the teachings herein.

FIG. 9 is a flow chart of a technique of determining update parameters for single and multi-hypothesis probability estimation used in entropy encoding.

FIG. 10 is a flow chart of a technique of determining update parameters for single and multi-hypothesis probability estimation used in entropy decoding.

FIG. 11 is a flow chart of a technique 1100 for entropy coding a sequence of syntax elements.

### DETAILED DESCRIPTION

Video compression schemes may include breaking respective images, or frames, into smaller portions, such as blocks, and generating an encoded bitstream using techniques to limit the information included for respective blocks thereof. The encoded bitstream can be decoded to re-create or reconstruct the source images from the limited information. The information may be limited by lossy coding, lossless coding, or some combination of lossy and lossless coding.

One type of lossless coding is entropy coding, where entropy is generally considered the degree of disorder or randomness in a system. Entropy coding compresses a sequence in an informationally efficient way. That is, a lower bound of the length of the compressed sequence is the entropy of the original sequence. An efficient algorithm for entropy coding desirably generates a code (e.g., in bits) whose length approaches the entropy. For a particular sequence of syntax elements, the entropy associated with the code may be defined as a function of the probability distribution of observations (e.g., symbols, values, outcomes, hypotheses, etc.) for the syntax elements over the sequence. Arithmetic coding can use the probability distribution to construct the code.

However, a codec does not receive a sequence together with the probability distribution. Instead, probability estimation may be used in video codecs to implement entropy coding. That is, the probability distribution of the observations may be estimated using one or more probability estimation models (also called probability models herein) that model the distribution occurring in an encoded bitstream so that the estimated probability distribution approaches the actual probability distribution. According to such techniques, entropy coding can reduce the number of bits required to represent the input data to close to a theoretical minimum (i.e., the lower bound).

In practice, the actual reduction in the number of bits required to represent video data can be a function of the accuracy of the probability model, the number of bits over which the coding is performed, and the computational accuracy of the (e.g., fixed-point) arithmetic used to perform the coding (also referred to as the resolution herein).

Implementations according to this disclosure address problems such as these by determining update parameters in probability estimation for entropy coding. The teachings herein incorporate model regularization, multi-hypothesis probability modeling with time-variant adaptation, and dynamic update parameter selection. A probability model, which may be represented by a cumulative distribution function (CDF), is used to estimate the probability of syntax elements associated with random variables to be coded into or from a bitstream. The probability model is updated after each symbol is coded using an update function controlled by a probability model parameter. According to the teachings herein, one or more update parameter modifiers may be determined and applied to the probability model parameter, allowing the update rate to be adjusted at a granular level, such as at a frame level, a tile level, or a slice level.

In some examples, a first update parameter modifier is determined for the probability model parameter that controls the update function. This update function can be the same for all of the multiple random variables to be coded, with the update parameter modifier providing flexibility to adjust the effective update rate. The first update parameter modifier can include a multiplier applied to a base update rate and can be signaled via an identifier in a header within the compressed bitstream. In some instances, a multi-hypothesis probability model comprising at least a first probability model and a second probability model is used, where each probability model has a different update rate. A second update parameter modifier can define an update rate gap between the first probability model and the second probability model. Hypotheses from the multiple models can be combined, such as through linear averaging, to determine a final probability for use in an arithmetic coding engine.

The base update rate can be a time-variant update rate that provides a higher adaptation rate at a beginning of use of the probability model as compared to a lower adaptation rate later in use. Updating the probability model can also include regularizing at least one probability value so that no probability of the updated probability model is below a defined minimum resolution. Regularization can include a weighted averaging of the updated probability model with a uniform distribution, which adjusts all cumulative probabilities simultaneously to correct the underlying probability model rather than merely clipping values at the arithmetic coder.

In some implementations, a multi-hypothesis probability model is used for only a proper subset of the multiple random variables to be coded, while a single hypothesis probability model is used for remaining random variables. The determination of whether to use a single hypothesis or multi-hypothesis probability model may be based on characteristics of the random variable, such as its type, usage, or coding channel.

As used in this disclosure, the term “random variable” refers to a variable that is coded into a bitstream, such as a bitstream defined in a video standard specification, and that may comprise multiple syntax elements. Each random variable has its unique probability estimation, generally represented by a cumulative distribution function (CDF). Because video codecs have different video standard specifications, the list of random variables (and their corresponding models) used in each codec may differ. Accordingly, those described herein are by example, and the teachings herein apply to various codecs and random variables.

An “update parameter modifier” refers to a value used to adjust the adaptation speed of a probability model. Implementations of this disclosure include an apparatus for entropy coding, which may include a processor and memory storing instructions that, when executed by the processor, cause the processor to execute any of the techniques described herein. The term apparatus encompasses encoders, decoders, transmitting stations, receiving stations, and computing devices. Implementations also include a non-transitory computer-readable medium storing instructions to execute any of the techniques described herein.

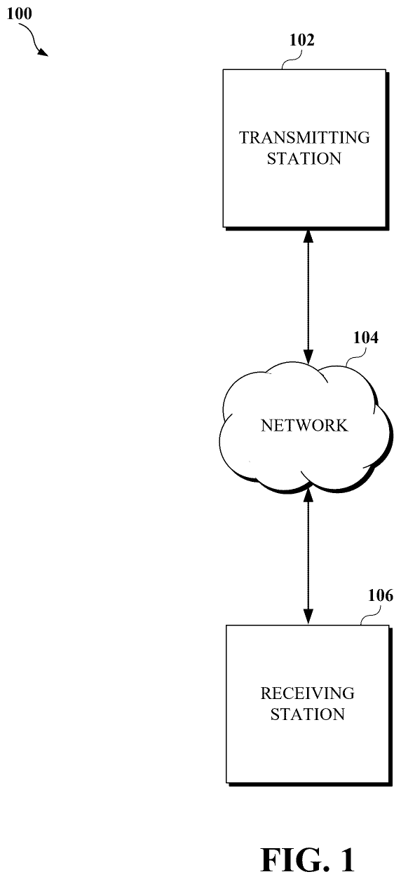

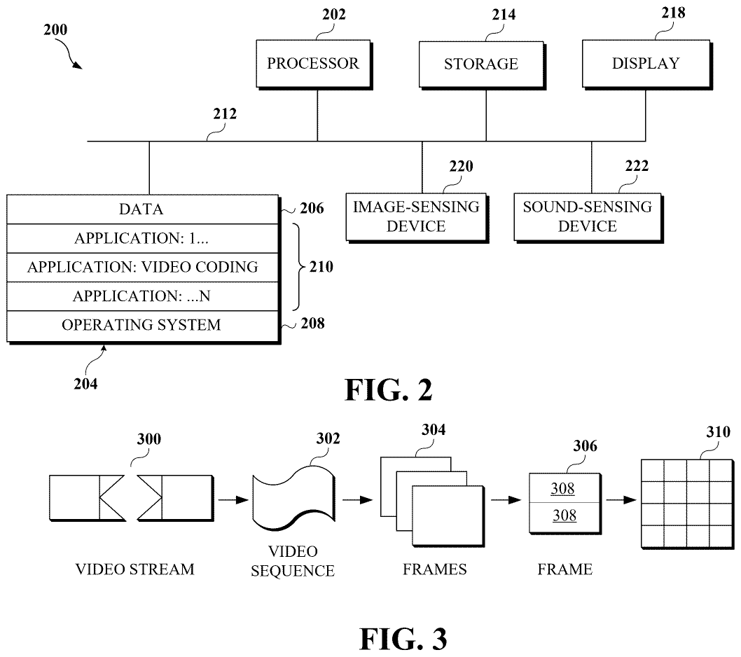

Further details of update parameter determination for single and multi-hypothesis probability estimation are described herein first with reference to a system in which the teachings may be incorporated. FIG. 1 is a schematic of an example of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a video streaming protocol based on Hypertext Transfer Protocol-based (HTTP).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

In some implementations, the video encoding and decoding system 100 may instead be used to encode and decode data other than video data. For example, the video encoding and decoding system 100 can be used to process image data. The image data may include a block of data from an image. In such an implementation, the transmitting station 102 may be used to encode the image data and the receiving station 106 may be used to decode the image data. Alternatively, the receiving station 106 can represent a computing device that stores the encoded image data for later use, such as after receiving the encoded or pre-encoded image data from the transmitting station 102. As a further alternative, the transmitting station 102 can represent a computing device that decodes the image data, such as prior to transmitting the decoded image data to the receiving station 106 for display.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random-access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include a video coding application that performs the techniques described herein. The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

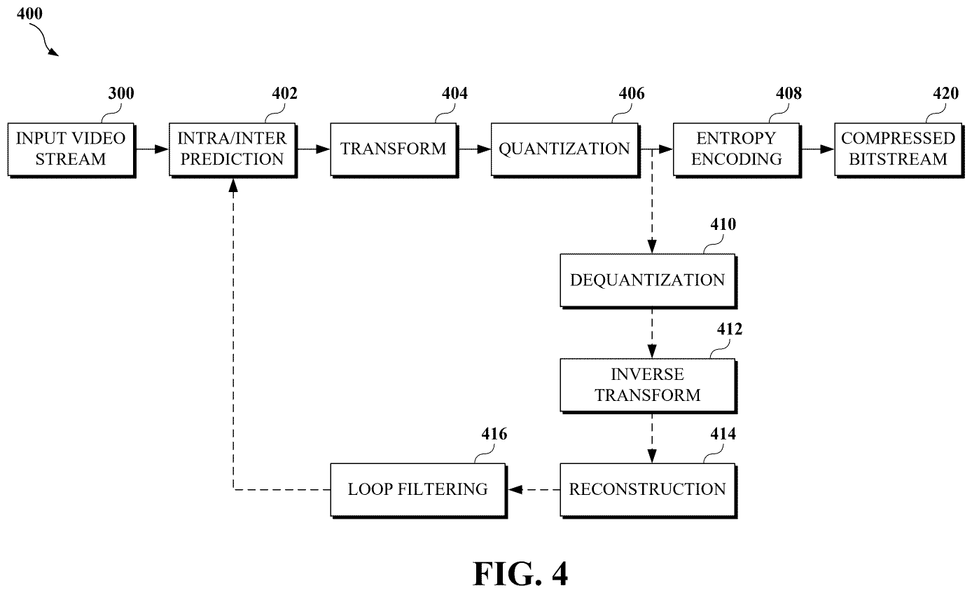

FIG. 4 is a block diagram of an example of an encoder 400. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

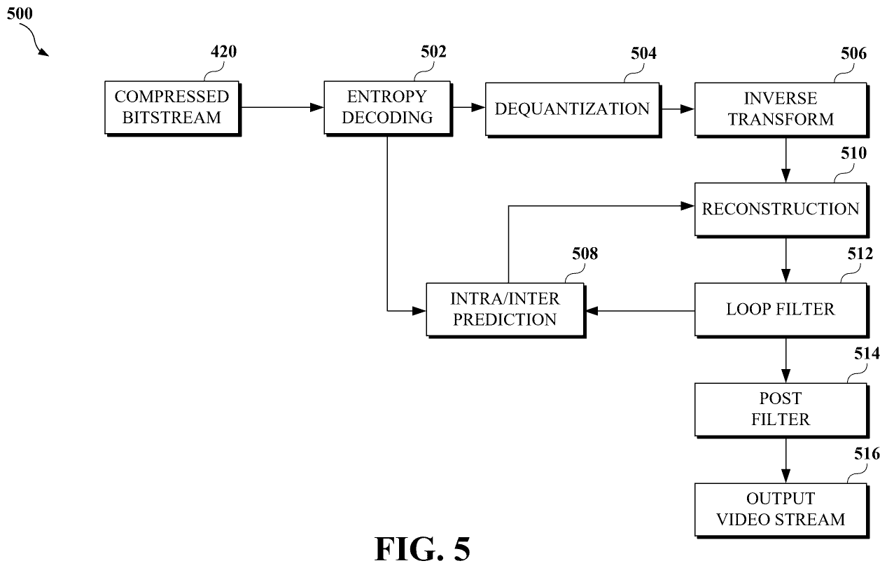

The reconstruction path (shown by the dotted connection lines) can be used to ensure that the encoder 400 and a decoder 500 (described below with respect to FIG. 5) use the same reference frames to decode the compressed bitstream 420. The reconstruction path performs functions that are similar to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

FIG. 5 is a block diagram of an example of a decoder 500. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400 (e.g., at the intra/inter prediction stage 402).

At the reconstruction stage 510, the prediction block can be added to the derivative residual to create a reconstructed block. The loop filtering stage 512 can be applied to the reconstructed block to reduce blocking artifacts. Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. In some implementations, the decoder 500 can produce the output video stream 516 without the deblocking filtering stage 514.

As can be discerned from the description of the encoder 400 and the decoder above, bits are generally used for one of two things in an encoded video bitstream: either content prediction (e.g., inter mode/motion vector coding, intra prediction mode coding, etc.) or residual or coefficient coding (e.g., transform coefficients). Encoders may use techniques to decrease the bits spent on representing this data. For example, a coefficient token tree (which may also be referred to as a binary token tree) may specify the scope of the value, with forward-adaptive probabilities for each branch in this token tree. The token base value is subtracted from the value to be coded to form a residual then the block is coded with fixed probabilities. A similar scheme with minor variations including backward-adaptivity is also possible. Adaptive techniques can alter the probability models as the video stream is being encoded to adapt to changing characteristics of the data. In any event, a decoder is informed of (or has available) the probability model used to encode an entropy-coded video bitstream so the decoder can decode the video bitstream.

That is, and as described initially above, a video codec may use arithmetic coding to materialize the entropy coding of syntax elements (such as the coding modes and residual coefficient data referenced above). The coding efficiency largely depends on the accuracy of the probability model. The probability model may be equivalently represented by either a probability mass function (PMF) or cumulative probability density function, also referred to as a cumulative distribution function (CDF) of the syntax element.

A desirable adaptive technique for updating a probability model may be implemented with an M-ary coding scheme, where a syntax element that has M possible outcomes, values, or observations can be directly coded using its probability model, without recourse to first binarizing the syntax element into a sequence of binary random variables. Provided an initial state of the probability for each outcome, the codec updates the probability model for each new observation.

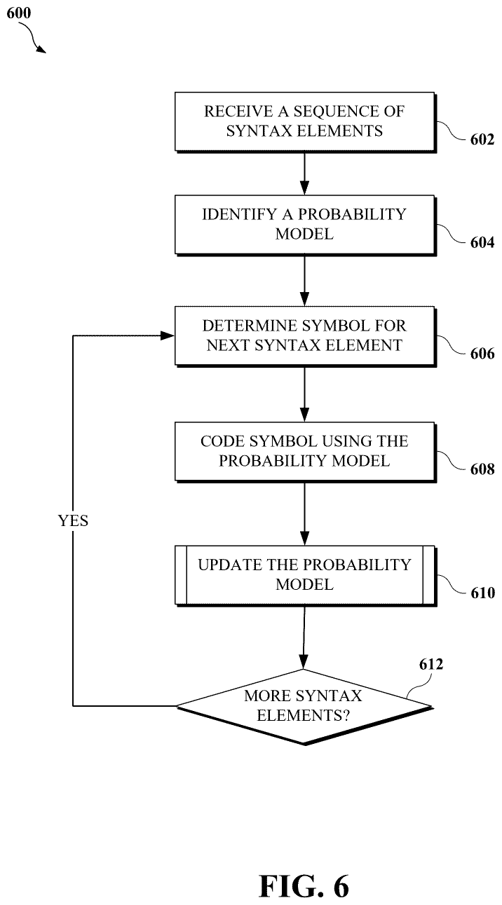

FIG. 6 is a flow chart of a technique 600 for entropy coding a sequence of syntax elements according to the teachings herein. The technique 600 may be performed at an entropy coding stage of an encoder, such as the entropy encoding stage 408 of the encoder 400, the entropy coding stage of a decoder, such as the entropy decoding stage 502 of the decoder 500, or the entropy coding stage of both an encoder and a decoder. While the technique 600 is shown as including steps arranged in a certain sequence, not all steps need to be performed, and the steps may be performed in a different sequence or be combined.

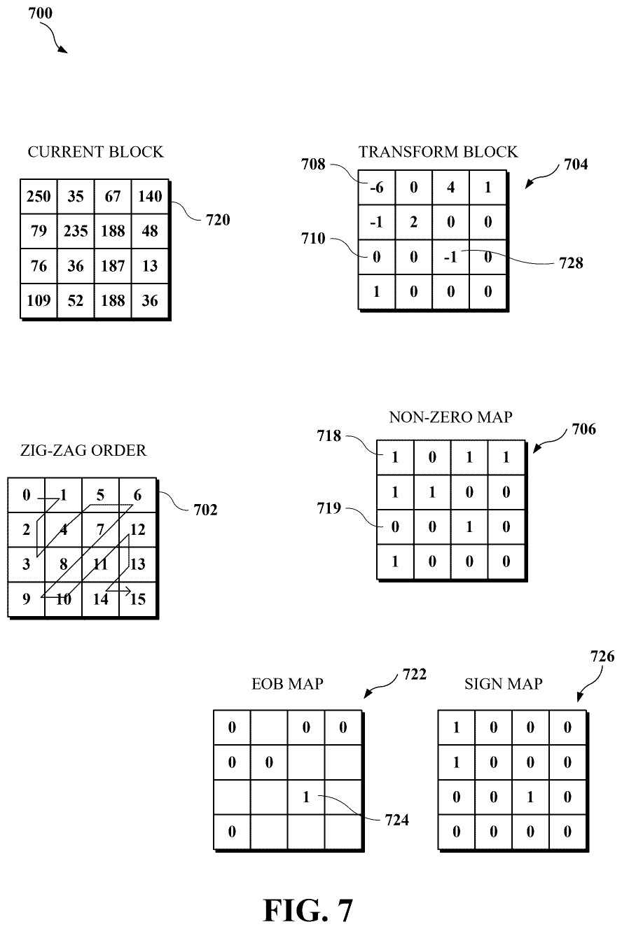

At 602, a sequence of syntax elements is received. Some examples of syntax elements and a sequence of syntax elements may be explained with reference to FIG. 7.

FIG. 7 is a diagram 700 illustrating syntax elements associated with coding transform coefficients. The diagram 700 depicts a current block 720, a scan order 702, a (e.g., quantized) transform block 704, a non-zero map 706, an end-of-block (EOB) map 722, and a sign map 726. The current block 720 is illustrated as a 4×4 block. However, any block size is possible. For example, the current block can have a size (i.e., dimensions) of 4×4 pixels, 8×8 pixels, 16×16 pixels, 32×32 pixels, or any other rectangular block size, including non-square dimensions. The current block 720 can be a block of a current frame. In another example, the current frame may be partitioned into segments (such as the segments 308 of FIG. 3), tiles, or the like, each including a collection of blocks, where the current block is a block of the partition.

The transform block 704 can be a block of a same or similar size to the size of the current block 720. The transform block 704 includes non-zero coefficients (e.g., a coefficient 708) and zero coefficients (e.g., a coefficient 710). As described above, the transform block 704 may include transform coefficients for the residual block corresponding to the current block 720. Also as described above, the transform coefficients are entropy coded, such as at the entropy coding stage 408 of FIG. 4, and as discussed in further detail below.

To encode a transform block, a video coding system may traverse the transform block in a scan order and encode (e.g., entropy encode) the transform coefficients as the transform coefficients are respectively traversed (i.e., visited). The scan order may depend upon the transform type or kernel used to generate the transform block or on some other variable associated with coding the current block and/or the transform block. The scan order may be a fixed scan order for all blocks. In the example shown, the scan order 702 is a zigzag scan order. Therein, the top left corner of the transform block (also known as the DC coefficient) is first traversed, the next coefficient in the scan order (i.e., the transform coefficient corresponding to the location labeled “1”) is traversed, and so on. Regardless of the scan order, a one-dimensional structure (e.g., an array or sequence) of transform coefficients can result from the traversal of the two-dimensional transform block using the scan order.

Another set of syntax elements associated with coding a transform block may be described with reference to the non-zero map 706, which may be derived from the transform block 704. The non-zero map 706 indicates which transform coefficients of the transform block 704 are zero and which are non-zero. A non-zero coefficient and a zero coefficient can be indicated with values one (1) and zero (0), respectively, in the non-zero map 706. For example, the non-zero map 706 includes a non-zero 718 at Cartesian location (0, 0) corresponding to the coefficient 708 and a zero 719 at Cartesian location (2, 0) corresponding to the coefficient 710. The EOB map 722 may be derived from the non-zero map, such as the non-zero map 706, and the scan order, such as the scan order 702. An end-of-block map indicates whether a non-zero transform coefficient of transform block is the last non-zero coefficient with respect to the scan order. If a non-zero coefficient is not the last non-zero coefficient in the transform block, then it can be indicated with the binary bit zero (0) in the end-of-block map. If, on the other hand, a non-zero coefficient is the last non-zero coefficient in the transform block, then it can be indicated with the binary value one (1) in the end-of-block map. As shown in this example, as the transform coefficient corresponding to the scan location 11 (i.e., the last non-zero transform coefficient 728) is the last non-zero coefficient of the transform block 704, it is indicated with the EOB value 724 of one (1); all other non-zero transform coefficients are indicated with a zero.

Another set of syntax elements associated with coding a transform block may be described with reference to the sign map 726. A sign map indicates which non-zero transform coefficients of a transform block have positive values and which transform coefficients have negative values. The sign map 726 illustrates a sign map for the transform block 704. In the sign map, negative transform coefficients can be indicated with a 1 and positive transform coefficients are identified with a 0 (e.g., transform coefficients that are zero are considered positive).

The sequence of syntax elements for entropy coding received at 602 may comprise one or more arrays derived from respective transform blocks. For example, syntax elements comprising the index positions of last non-zero transform coefficients for respective transform blocks, such as from the EOB map 722, may be coded using the entropy coding techniques described herein, or by other lossless coding techniques. By coding the EOB in the scan order, any zeros in the array of transform coefficients after the EOB value 724 in the scan order may be ignored in the coding. For example, the 1D array corresponding to the transform block 704 has the entries [−6, 0, −1, 0, 2, 4, 1, 0, 0, 1, 0, −1, 0, 0, 0, 0]. The final four zeros in the sequence may be omitted from entropy coding. Further, syntax elements comprising the sequence of values of the sign map (e.g., in a scan order) may be coded using the entropy coding techniques described herein, but preferably are encoded as raw bits (e.g., bypassing entropy coding). By coding the sign map information, the sequence of syntax elements for entropy coding received at 602 may correspond to the absolute values of the magnitudes of the transform coefficients. For the transform block 704, the entries of the array would correspond to [6, 0, 1, 0, 2, 4, 1, 0, 0, 1, 0, 1].

In the examples described herein, the sequence of syntax elements for entropy coding received at 602 comprises an unsigned array of transform block magnitudes (e.g., transform coefficients, whether quantized or not) or their encoded representations from the bitstream. However, other syntax elements may be entropy coded according to the teachings herein.

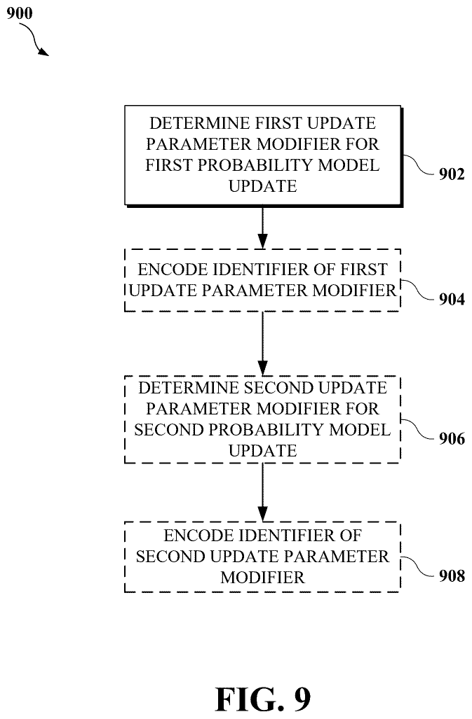

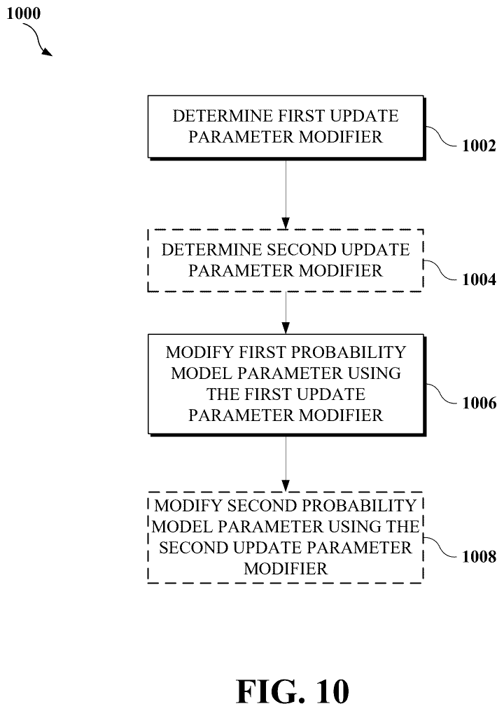

Referring again to FIG. 6, at 604, the technique 600 includes identifying (e.g., selecting, determining) a probability model for entropy coding the sequence. The probability model may be identified based on the syntax elements. For example, a probability model used for entropy coding arrays of magnitudes of transform blocks may be different from a probability model used for entropy coding a sequence of other variables. A probability model used for entropy coding DC coefficients of arrays of magnitudes of transform blocks may be different from a probability model used for entropy coding the remaining transform coefficients of the arrays. A probability model may be a new probability model with initial values as described below or may be inherited from a reference frame or earlier blocks or sets of blocks from the current frame. The probability model is described in additional detail below. Identifying the probability model at 604 may include determining one or more update parameter modifiers as described with respect to FIGS. 9 and 10.

While the following description uses transform coefficients as an illustrative example, the teachings herein are applicable to entropy coding of any syntax elements associated with random variables to be coded, including but not limited to coefficient values, filter types, intra-coding modes, inter-coding modes, partition modes, and transform modes.

Once the probability model is identified at 604, the technique 600 uses the probability model starting at 606 by determining an outcome or observation for the next syntax element. The next syntax element may be the first syntax element in the sequence to be coded. In an example of the teachings herein, the syntax elements may correspond to quantized transform coefficients, and the sequence may be processed in reverse scan order. In some implementations, the absolute values of the magnitudes fall within the range [0, 2¹⁶] because the magnitudes fall within the range [−2¹⁵, 2¹⁵]. The first observation of the transform coefficient array [6, 0, 1, 0, 2, 4, 1, 0, 0, 1, 0, 1], by example, is 1.

Once the observation is determined at 606, the observation is coded at 608 using the probability model. In some implementations of entropy coding, an observation is binarized before coding. In the implementations discussed herein, the probability model described above allows for entropy coding of the observation without binarization. To do so, the observation may generally be represented by one or more symbol(s) or token(s) that represent ranges of values for the syntax element, context modeling, and arithmetic coding. Accordingly, determining an observation for the syntax element at 606 may more particularly include determining a symbol for the syntax element, and coding the observation using the probability model at 608 may more particularly include coding the symbol using the probability model.

Representing the observation by one or more symbol(s) includes using the observation to select the one or more symbol(s) from available symbols. The cardinality of available symbols, and hence their respective ranges, may take advantage of the fact that while the range of magnitudes is relatively wide ([−2¹⁶, 2¹⁶] in this example), the observations for any particular frame or block often correspond to the integer values closest to 0. For example, a first symbol base range (BR) can correspond to four possible outcomes or observations for the absolute value of the magnitude of (e.g., quantized) transform coefficients, namely [0,1, 2,>2]. The next following symbol may comprise one or more low range (LR) symbols, which each correspond to a residual value that is, e.g., a difference of the magnitude over the upper limit of the previous symbol. For example, a symbol LR1 may be further used for encoding observations having a lower limit value of 3 and corresponding to four possible outcomes for the residual value, namely {0,1, 2,>2}. A symbol high range (HR) may be used for the coding of higher absolute values of the transform coefficients (e.g., up to 2¹⁶). Because of the characteristic clustering of the values about 0, the range of residual values over the upper limit of the previous symbol may be wider for the HR symbol.

Table 1 below shows an illustrative example of symbols and how the absolute value of the magnitude of a transform coefficient may be represented by the BR symbol, and optionally LR and HR symbols. Other symbol schemes may be used for other types of syntax elements.

TABLE I

| Symbol | Transform Coefficient Value |
|---|---|
| BR | 0-2 |
| LR1 | 3-5 |
| LR2 | 6-8 |
| LR3 | 9-11 |
| LR4 | 12-14 |
| HR | 15-2¹⁶ |

For example, if these symbols were used for entropy coding a magnitude of 6, as in the example array above, the symbols BR, LR1, and LR2 would be sufficient to represent the magnitude. In this example, each of the BR and LR symbols correspond to two bits. However, the number of bits, and hence the ranges for each symbol can vary. For example, the BR symbol may correspond to two bits, while the LR symbols may correspond to three bits. Further, additional symbols or few symbols may be used (with the ranges adjusted accordingly). For example, the HR symbol may be further deconstructed so that the high-range values shown are parsed into smaller ranges of values. The symbols may be different and may depend on the resolution or other characteristics of the frames, images, or blocks being encoded and decoded.

As described initially, the probability model may be equivalently expressed by the PMF or the CDF of a variable. For example, an M-ary random variable has a PMF defined as follows:

$${\overline{P}}_{n} = [ {p}_{1} ( n ) , {p}_{2} ( n ) , … , {p}_{M} ( n ) ] \qquad ( 1 )$$

The variable has M possible outcomes for an observation at time n (e.g., the location in a sequence being coded). In this example, M∈[2,16]. Each of the probabilities is non-negative and their sum is 1. The probability model of an M-ary coding scheme for the variable may be represented by the following CDF:

$${\overline{C}}_{n} = [ {c}_{1} ( n ) , {c}_{2} ( n ) , … , {c}_{M - 1} ( n ) , 1 ] \qquad ( 2 )$$

The probability cₖ(n), also referred to as a cumulative probability herein, is the probability that the variable, evaluated at k, will take on a value less than or equal to k, where k is an integer such that k∈{1, 2, . . . M}.

The cumulative probabilities of a probability model, when not inherited as described above, may be initialized with values dependent on the value M. For example, where a syntax element has two possible outcomes (e.g., binary 0 or 1), the values may be initialized to conform to an equal probability, e.g., C̅ₙ=[0.5,1].

The probability model comprising a unique CDF for each of the BR and LR (e.g., LR1-LR4) symbols, each CDF of which is conditioned on reference (e.g., previously-coded) coefficients. Context modeling for a respective symbol to be coded, also called context derivation, may be based on an expected correlation of the symbol to symbols representing the other observations of the syntax elements. For example, context modeling for the BR symbol may be conditioned on the previously coded coefficients of the current transform block, and optionally on one or more neighboring samples from other transform blocks within the current frame. Context modeling for each of the LR symbols may be conditioned on previously coded coefficients of neighboring samples. The neighboring samples may be determined based on the transform kernel or type—that is, the neighboring samples for one transform kernel, such as a two-dimensional (2D) transform kernel, may be different from the neighboring samples for another transform kernel, such as a one-dimensional (1D) transform kernel (e.g., a horizontal or vertical transform kernel). Context modeling approaches may vary for other types of syntax elements based on expected correlations specific to those syntax elements.

In the arithmetic coding step, given a context, the symbol is coded using the context together with the probability from the probability model associated with the symbol in an arithmetic coding engine. The cumulative probability in each entry of equation (2) above may be scaled by 2¹⁵ so that the calculations are performed using integers (and not percentages). That is, the cumulative probability cₖ(n) is represented by 15-bit unsigned integers so that the arithmetic operations may be completed using integer values. The cumulative probabilities may be scaled by other factors for a different integer resolution in the calculations.

Further examples of context modeling and arithmetic coding using context modeling may be obtained by reference to J. Han et al., “A Technical Overview of AV1”, arXiv: 2008.06091v2 [eess.IV] (Feb. 8, 2021), Section VI of which is directed to the entropy coding system of the AV1 codec and which is incorporated herein in its entirety by reference, and to I. H. Witten, et al., “Arithmetic coding for data compression”, Communications of the ACM, vol. 30, no. 6, pp. 520-540 (1987), which is incorporated herein in its entirety by reference.

After the observation is coded at 608 using the probability model, the probability model is updated at 610. Each CDF for a symbol may be updated according to the following equations.

$${c}_{m} ( n ) = \{ \begin{matrix}{c}_{m} ( n - 1 ) \cdot ( 1 - α ) , & \& m < k \\ {c}_{m} ( n - 1 ) + α \cdot ( 1 - {c}_{m} ( n - 1 ) ) , & \& m \geq k\end{matrix} \qquad ( 3 )$$

In equation (3), k is the index for the new observation in the order of the sequence being encoded, m is the index for the cumulative probability within the CDF of a symbol, and a is the model update rate, also referred to herein as the update rate. The update rate a determines the weight assigned to a new observation relative to past observations when updating the probability model. The update rate α may take values in the range (0, 1). A higher value of a assigns greater weight to the new observation, resulting in faster adaptation of the probability model to recent data. A lower value of a assigns greater weight to past observations, resulting in slower adaptation and a more stable probability model.

According to some implementations of updating a probability model, a fixed update rate may be used. One known example is 0.95. A fixed update rate, while simple to implement, does not address time variance in the probability distribution. More specifically, a fixed update rate does not address the desirability of providing for a higher adaptation rate at the beginning of use of the probability model (e.g., at the beginning of a frame or some portion of a frame).

An adaptation rate refers to how quickly the model updates a probability for an observation. Instead of a fixed update rate, the update rate may be formulated to provide a higher adaptation rate at the beginning of use of the probability model, such as at the beginning of a frame, tile, or slice. The update rate may do this by weighting the probability update for a new symbol differently at the beginning of use of the probability model as compared to later in use. The update rate may consider how many symbols are coded before and with the coding of the current observation, where the count is reset at the beginning of each frame, tile, or slice. The update rate may be a deterministic update rate that provides the higher adaptation rate at the beginning of use than after a defined number of symbols have been coded. One time-variant update rate for a probability model (e.g., for a respective symbol) that may be used is shown below.

$$α = 1 / {2}^{3 + I ( count > 15 \} + I ( count > 32 ) + min ( {log}_{2} ( M ) , 2 )} \qquad ( 4 )$$

In equation (4), count refers to the number (e.g., cardinality) of symbols coded through the current observation. I (comparison) is a function that returns 1 if comparison is true (that is, if count>15 and/or count>32) and otherwise returns 0 (i.e., if the comparison is not true). Equation (4) achieves the functionality of providing the higher adaptation rate at the beginning while slowing down and/or stabilizing as more observations are received. The threshold values used for comparison to count may vary, and there may be more or fewer comparisons. The examples in this disclosure use different thresholds for the counter (e.g., 15, 30, 32). However, the teachings herein are not limited to or by any specific threshold values used herein, and other values are possible.

While a time-variant update rate, such as the example of equation (4), may provide more efficient compression in entropy coding than a fixed rate in some situations, it has some drawbacks. For example, a random variable that has a strongly-biased probability distribution may result in the probability associated with a low likelihood event to approach zero. More specifically, when the probability model becomes strongly biased toward certain outcomes, the probability for a low-likelihood event may become smaller than the probability resolution, which is ½¹⁵ in the examples described herein. Because the cumulative probabilities are represented as 15-bit unsigned integers, a probability value smaller than the resolution cannot be represented and effectively becomes zero. When this occurs, the corresponding CDF interval becomes 0 (e.g., cₖ₋₁(n)=ck(n)).

An attempt to code with zero probability in theory leads to infinite codeword length and would likely corrupt the arithmetic coding. This is because a smaller probability typically produces a longer codeword than a larger probability. To avoid coding using 0, a preset minimum probability pₘᵢₙ may be used instead of the calculated probability used for the update of the CDF. That is, the arithmetic coding selects the greater of the determined probability value or probability pₘᵢₙ, but the CDF remains unchanged.

While this solution addresses the identified problem in the arithmetic coding process, problems can arise because the CDF remains unchanged. In practice, near-zero probability events may result because each update to the probability model increases the probability of the observed outcome and decreases the probabilities of other outcomes. When certain outcomes are observed much more frequently than others, the probabilities of the infrequently observed outcomes may be pushed toward zero. When a near-zero probability event happens, it is a good indicator that the current probability distribution is overly biased. Addressing this bias may be achieved by increasing the probabilities of these near-zero probability events within the probability model. In some implementations of the technique 600 herein, updating the probability model at 610 includes regularizing the probability model that eliminates a zero-probability event in the CDF itself and eliminates the need to provide the preset minimum probability pₘᵢₙ for the arithmetic coding.

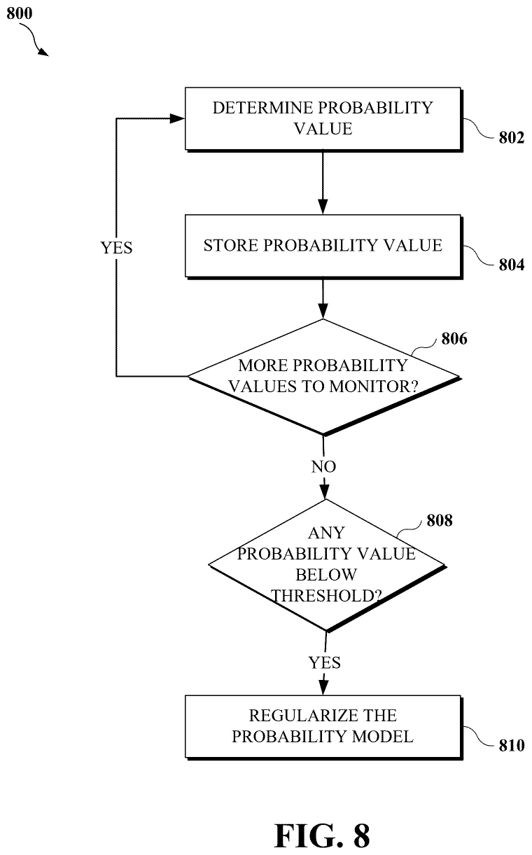

An example of regularizing the probability model may be described with reference to the technique 800 of FIG. 8. In general, at the end of each update of a probability model, if there is a probability that goes below (e.g., becomes less than) a minimum value V, a uniform distribution can be applied as a regularization term to adjust all cumulative probabilities so that, for all values m, cₘ₋₁(n)≠cₘ(n). The minimum value V may correspond to the preset minimum probability pₘᵢₙ. The minimum value may correspond to the sample space M of the random variable. For example, V=2¹⁵/M for an M-ary random variable. The minimum value V may correspond to the defined minimum resolution referenced herein.

The technique 800 includes monitoring probability values of the PMF. Monitoring includes iterating through each probability value in the PMF to identify a minimum probability value. The iteration may begin at 802, where a current probability value pₘ(n) is determined.

Determining the current probability value may be performed during or after the update step by comparing the current cumulative probability cₘ(n) to the previous cumulative probability cₘ₋₁(n). That is, for example, a difference may be calculated as pₘ(n)=cₘ(n)−cₘ₋₁(n). At 804, the current probability value pₘ(n) may be stored. Alternatively, the current probability value pₘ(n) may be stored at 804 only if it is the lowest probability value yet to be stored. For example, current probability value pₘ(n) may be compared to stored probability value (e.g., initialized at 1) and be stored only if it is below the currently stored value. At 806, a query to determine whether there are more probability values to monitor may be performed. The check may include determining whether m<M is true or false, in some implementations.

If there are more probability values to monitor in response to the query at 806, the technique 800 returns to determine the next probability value at 802. If there are no further probability values to monitor at 806, the technique 800 advances to 808 to determine whether any probability value is below the threshold V. The determination at 808 may be performed by comparing the probability value(s) stored at 804 to the threshold V. If no probability value is below the threshold V, the method ends. Otherwise, the probability model is regularized at 810.

As referenced above, regularizing the probability model at 810 includes applying a uniform distribution as a regularization term to adjust the updated cumulative probabilities. The uniform distribution may be a uniform CDF for the M-ary random variable represented by:

$${U}_{m} = \frac{m}{M} = {\overline{C}}^{u} = [ {c}_{1}^{u} , {c}_{2}^{u} , … , {c}_{M - 1}^{u} , 1 ] = [ \frac{1}{M} , \frac{2}{M} , … , \frac{M - 1}{M} , 1 ] \qquad ( 5 )$$

The uniform CDF Uₘ may be normalized by the scaling factor, which is 2¹⁵ in the examples described herein

$$( e . g . , {U}_{m} = \frac{{2}^{15}}{M} m ) ,$$

so that integer math may be used for the regularization, but this is not required.

The uniform CDF may be applied to regularize the minimum probability in the current cumulative distribution to be at or above V when that minimum probability is less than V. The minimum probability may be the lowest probability value stored at 804. Assuming the minimum probability is pₘ and pₘ<V, a linear combination of the current CDF (e.g., an updated CDF) and the uniform CDF can be used to raise pₘ to V. Thus, the following equality can be formed:

$${p}_{m} + α \frac{1}{M} = ( 1 + α ) V \qquad ( 6 )$$

The new value \hat{P}ₘ for pₘ may be solved for as follows:

$${\hat{p}}_{m} = \frac{{p}_{m} + α \frac{1}{M}}{1 + α} = V = {p}_{min} \qquad ( 7 )$$

Solving for a results in:

$$α = \frac{V - {p}_{m}}{\frac{1}{M} - V} \qquad ( 8 )$$

To further simplify the regularization, the update rate a may be approximated as M·V. This allows the updated probability value \hat{P}ₘ to minimally exceed V. Thus, the regularization process used at 810 to generate the new probability model Ĉₙ (i.e., to adjust all cumulative probabilities of the current probability model C̅ₙ simultaneously after the update) may be represented as:

$${\hat{C}}_{n} = \frac{{\overline{C}}_{n} + α {U}_{𝔪}}{1 + α} \qquad ( 9 )$$

Regularizing the probability model is optional. That is, regularizing the probability model while updating the probability model at 610 may be omitted in some implementations of the teachings herein. Whether the probability model is regularized or not, the technique 600 may continue after updating the probability model by checking for more syntax elements for coding at 612 (e.g., after coding each symbol of the current observation according to the teachings herein). If there are no further syntax elements, the technique 600 ends for the current sequence of syntax elements.

Referring again to FIG. 6, the technique 600 may be used for both entropy encoding and entropy decoding. The description above uses an example where the sequence of syntax elements comprises the transform coefficients for encoding for simplicity of explanation. For decoding, the sequence of syntax elements may include codewords (e.g., sequences of bits) that represent the encoded variables, such as EOB positions, quantized coefficients, etc.

The update rate described above for updating the probability model at 610 is a time-variant update rate used with the CDF associated with one M-ary random variable. The probability model C̅ₙ can benefit from the time-variant update rate, which provides a higher update rate when fewer symbols have been coded and a lower update rate as more symbols are coded.

Another approach to entropy coding is to use multi-hypothesis estimation, in which each random variable maintains two or more probability tables of different fixed update rates, i.e., hypotheses. The final probability model for entropy coding can be a linear combination of the respective hypotheses. While this approach improves efficiency over using a fixed update rate with a single probability model, the time-variant update rate is more flexible and hence can improve coding efficiency. This multi-hypothesis estimation may be improved by maintaining two probability models (e.g., two CDFs) for each random variable, in which each model uses a different time-variant update rate.

To implement such a solution, for example, the technique 600 may identify each of two probability models at 604. Each probability model may comprise a respective CDF, such as the following two CDFs:

$${\overline{C 1}}_{n} = [ {a}_{1} ( n ) , {a}_{2} ( n ) , … , {a}_{M - 1} ( n ) , 1 ] \qquad ( 10 )$$

$${\overline{C 2}}_{n} = [ {b}_{1} ( n ) , {b}_{2} ( n ) , … , {b}_{M - 1} ( n ) , 1 ] \qquad ( 11 )$$

At the start of a new sequence (e.g., at the start of a new frame), the two probability models may have the same values. Alternatively, the two probability models may be inherited (e.g., from a reference frame) with different values. For example, an identification of a reference frame having a stored probability table may be made in the header of the current frame being coded.

At 606, the observation may be used to generate a respective hypothesis (e.g., the cumulative probability) using each of the probability models. Coding the observation using the probability models would use, for a respective cumulative probability, a linear combination of the two hypotheses as input to the arithmetic coding. For example, assuming a first update rate used with C̅1̅, is α1, a second update rate used with C̅2̅, is α2, the linear combination to produce the cumulative probability cₘ(n) for use in arithmetic coding at 608 is:

$${c}_{m} ( n ) = ω {a}_{m} ( n , α 1 ) + ( 1 - ω ) {b}_{m} ( n , α 2 ) \qquad ( 12 )$$

In equation (12), ω∈(0,1). The actual value used for ω may be determined by experimentation. In an example, ω=0.5.

At 610, each probability model is separately updated using respective time-variant update rates α1 and α2. The time-variant update rates α1 and α2 are different from each other. In some implementations, at least one of the time-variant update rates α1 and α2 provides a higher adaptation rate at the beginning of use of the probability model as compared to later in use. In some implementations, the functions are count-based functions modified based on equation (4). For example, the time-variant update rates may be used as follows:

$$α 1 = 1 / {2}^{4 + I ( count > 7 ) + I ( count > 15 ) + min ( {log}_{2} ( M ) , 2 )} \qquad ( 13 )$$

$$α 2 = 1 / {2}^{2 + I ( count > 7 ) + I ( count > 15 ) + min ( {log}_{2} ( M ) , 2 )} \qquad ( 14 )$$

In this example, each of the time-variant update rates α1 and α2 is represented by a step function that determines a higher update rate when the number (e.g., cardinality) of symbols coded through the current observation (i.e., the value of count) is low and results in a lower update rate as the value of count increases above each comparison value, in this example values of 7 and 15. As can be seen from the comparison values, the time-variant update rates α1 and α2change (i.e., step down) on the same counts. The time-variant update rate α2 begins and finishes at a higher update rate than the time-variant update rate α1.

This time-variant multi-hypothesis probability model update may be combined with regularizing the probability model. In this combination, one or both probability models C̅1̅ₙ and C̅2̅ₙ may be separately regularized according to the method of FIG. 8 while updating a probability model to eliminate zero (or near-zero) probabilities from the cumulative probabilities. Multi-hypothesis probability estimation reduces the variance of the random variables being modeled and approximates the true probability more precisely.

The example of multi-hypothesis probability estimation described above is a dual hypothesis probability estimation. As compared to a baseline where the entropy coding maintains one copy of the probability estimation for each random variable (formed of the syntax elements described herein) that needs to be coded into and from the bitstream, the dual hypothesis approach may result in an encoder and decoder maintaining two copies of the probability estimations for each random variable. Each copy may have its own initial probability estimation and its own probability update rate. While coding gains may be achievable, the dual hypothesis approach requires twice the memory to store the probability estimates. This increased memory usage may be a constraint for a decoder, particularly for a hardware decoder.

Instead of maintaining multiple hypotheses for each random variable, a tradeoff between the coding efficiency gain and increased memory usage of the multi-hypothesis approach may be achieved by selectively updating certain random variables in the bitstream with multi-hypothesis estimation. That is, not all random variables in the bitstream have equal weights in their contribution to coding gain. Accordingly, the random variables can be broken into different categories such that the random variables demonstrating coding gains with acceptable memory increase can use multi-hypothesis probability estimation (two or more models) while those with lesser coding gains compared to the increased memory requirements use a single (e.g., conventional) probability estimation.

Entropy coding a sequence of syntax elements using the selective update of multi-hypothesis probability estimation may be performed according to the technique 600 of FIG. 6. However, the identification of the probability model at 604 can include an additional step of identifying whether the probability model used is a single hypothesis probability estimation or a multi-hypothesis probability estimation. This may be performed by grouping the random variables representing respective sequences of syntax elements into different categories, where a first category uses a single model, and a second category uses multiple models. Although the examples herein use a dual hypothesis probability estimation, the multi-hypothesis probability estimation may include 2, 3, 4, or more probability estimations. Accordingly, the random variables may be grouped into more than two categories, each representing the number of probability estimations used.

In some implementations, the random variables may be grouped into different categories based on their usage in the codec. For example, coefficients, filter types, intra-coding modes, inter-coding modes, partition modes, transform modes, etc., may be grouped into the categories. The grouping may be based on comparing the coding improvement using a single model to one or more multi-hypothesis models and the increased memory requirements with those of other variables. Those random variables with the largest coding improvement as compared to the increased memory requirements may be grouped together to use multi-hypothesis probability estimation while others remain using a single hypothesis probability estimation.

In some implementations, the random variables may be grouped into different categories based on their properties. For example, the random variables may be grouped based on whether they are coded into or out of the luma channel or the chroma channel. The random variables may be grouped based on a combination of their usage and their properties. That is, some random variables may be sub-divided according to their properties. For example, all coefficients may be grouped into a single hypothesis probability estimation regardless of channel for entropy coding, but syntax elements of transform modes may be divided such that those of the luma channels use multi-hypothesis probability estimation while those of the chroma channel use a single hypothesis probability estimation.

In some implementations, random variables may be grouped according to the hierarchical properties. For example, random variables may be grouped by sequence level, frame level, or coding block level. Grouping according to hierarchical properties may be used alone or may be combined with grouping by usage and/or grouping by their properties.

The selective update scheme for multi-hypothesis probability estimation described herein can divide all random variables into two subsets such that a multi-hypothesis approach is applied on only one subset. There are multiple ways to determine the division. Once the division is determined, it may be fixed so that an encoder and a decoder use the same division when encoding and decoding a bitstream. In some implementations, an encoder and a decoder share at least two preset divisions of the random variables, where each preset division defines which random variables use single hypothesis probability estimation and which use multi-hypothesis probability estimation.

Each preset division defines its respective subsets of random variables. A variable may be signaled in a header within the bitstream to indicate which preset division is to be used. For example, a one-bit signal value of 0 can indicate that a first preset division is used, and a signal value of 1 can indicate that a second preset division is used. In other implementations, more than two preset divisions may be shared between the encoder and the decoder, with additional bits used to signal which preset division is to be used.

In an example, instead of updating probability estimates using a dual hypothesis approach for all random variables, a subset of random variables including filter types, intra-coding modes, and inter-coding modes are updated using a multi-hypothesis approach, while all other random variables are updated using a single hypothesis approach.

By updating only a subset of random variables with a multi-hypothesis approach, coding efficiency improvement may be achieved while reducing memory increase as compared to applying multi-hypothesis to all random variables. While a dual hypothesis approach is described, the teachings herein can be applied to a multi-hypothesis approach with three or more hypotheses.

As explained above, a cumulative distribution function (CDF) is one example of a probability model that may be used to track the syntax element probabilities for arithmetic coding. A per-symbol update approach is used to estimate the probabilities, where, every time a symbol is coded, the associated CDF is updated accordingly. The update may be performed according to equation (3) in some implementations. In equation (3), α controls the update rate (and is referred to as the update rate herein), i.e., how much weight is given to the most recent observation versus past observations. The parameter α may be calculated using a predefined table based on the values of M and the number of occurrences within at least a portion of a frame, such as a tile, as shown in equation (4), reproduced below.

$$α = 1 / {2}^{3 + I ( count > 15 ) + I ( count > 32 ) + min ( {log}_{2} ( M ) , 2 )}$$

Whether a single hypothesis estimation or multi-hypothesis estimation is used for updating a probability model (e.g., a CDF), the time-variant update rates described above use update formulas that do not change across random variables. For example, equation (4) is a time-variant update rate formula for a CDF associated with one M-ary random variable. The same formula may be used with the CDFs associated with different M-ary random variables within a frame. The same is true for multi-hypothesis estimations, which can use two or more update rate formulas, such as equations (13) and (14) described above.

Variations in one or more update rates can provide flexibility to the update process and hence to the probability model used to code syntax elements into and from a bitstream. For example, the original update rate can effectively be changed to be higher or lower, which may result in a probability model that more closely matches the actual probability distribution of the syntax elements being coded.

FIG. 9 is a flow chart of a technique 900 of determining update parameters for single and multi-hypothesis probability estimation used in entropy encoding. The technique 900 may be performed as part of entropy encoding a sequence of syntax elements such as the technique 600 as described with regards to FIG. 6 and/or the modification of FIG. 6 to use the selective update of multi-hypothesis probability estimation. More specifically, the identification of the probability model at 604 can include the additional step(s) of the technique 900.

At 902, an update parameter modifier is determined. The update parameter modifier may be referred to as a first update parameter modifier because a multi-hypothesis probability estimation may be used for at least some random variables within a frame or a proper subset of blocks of a frame, such as a tile. An example of an update parameter modifier is next described with reference to equation (4). Assuming the probability model uses equation (4) in its update function, the update parameter modifier may be a value that modifies the update rate a to be higher or lower.

In some implementations, the update parameter modifier is an update parameter multiplier β such that the modified update rate is α×β. The update parameter multiplier β may be a power of two. In some implementations, β=2^{1-P}, where P is an integer in the range [0, 3]. Because β is a power of two, modifying the probability model parameter α by β may be performed using a bit-shift operation rather than a multiplication operation, which can reduce computational complexity.

At an encoder, the update parameter modifier may be determined at 902 at a frame level, a tile level, or a slice level. The entropy coding may be performed at the slice or tile level to facilitate parallel processing. The update parameter modifier may be determined using predefined rules based on characteristics of a frame or frame portion, such as content complexity, motion activity, or whether single or multi-hypothesis probability estimation is used. The predefined rules may be established empirically and stored as a lookup table or heuristic at the encoder. In some implementations, the update parameter modifier may be specified by a user or external process.

In some implementations, an encoder can determine the update parameter modifier using an exhaustive search. For example, the encoder can entropy code random variables at a frame level or slice level and select the update parameter modifier that results in the fewest bits for the random variables of the frame or frame portion.

More specifically, the probability model is initialized at the start of a slice, and then the random variables are entropy coded according to the coding order of the blocks using each possible value for the update parameter modifier. In the example where the update parameter modifier is a multiplier β as described above, possible values for the update parameter multiplier β include 2, 1, ½, or ¼. Thus, the random variables may be entropy coded using α×2, α×1, α×½, and α×¼, and the resulting bitstream lengths may be compared. The value for the update parameter multiplier β may be determined as the value that results in the fewest bits.

The remaining steps of the technique 900 in FIG. 9 are dashed to indicate that they are optional. For example, in some implementations, the frame or frame portion (e.g., a tile) may only use single hypothesis estimation. As described above, an encoder may determine the update parameter modifier at 902 based on predefined rules. If these rules are shared with a decoder, the decoder may apply the same rules to determine the first update parameter modifier without signaling from the encoder.

At 904, the encoder may encode an identifier of the first update parameter modifier determined at 902. The identifier may be encoded into a bitstream. The identifier may be an index into a table of available modifiers, or the identifier may be a value from which the first update parameter modifier can be derived. In the example described above, the first update parameter modifier β may be a non-integer value (e.g., 2, 1, ½, or ¼). In such implementations, the identifier may be the value of P where P is an integer in the range [0,3] and β=2^{(1-P)}. Thus, two bits may be used to signal the first update parameter modifier.

In implementations where single hypothesis estimation is used and the encoder encodes an identifier of the first update parameter modifier at 904, the encoder may optionally determine a second update parameter modifier at 906 and encode an identifier of the second update parameter modifier at 908. For example, a default value of 0 may be determined and encoded. While the second update parameter modifier is not used in single hypothesis estimation, encoding a default value may provide consistency in the frame or frame portion (e.g., tile) header, which can simplify decoder implementation.

In implementations where multi-hypothesis estimation is used for a frame or frame portion, an update parameter modifier for a second probability model, also called a second update parameter modifier, is determined at 906. Like the determination of the first update parameter modifier, the determination of the second update parameter modifier can be performed using multiple techniques. An example of the second update parameter modifier is described below.

The example of the second update parameter modifier, like the first update parameter modifier, is described with reference to equation (4). The second update parameter modifier may be a value based on the first update parameter modifier. In some implementations where the first update parameter modifier is the update parameter multiplier β, the second update parameter modifier is an update parameter multiplier y such that the modified update rate for the second probability model is α×β×γ. The update parameter multiplier γ may be a power of two. In some implementations, γ=2^{-Q)} where Q is an integer in the range [0,3]. In other implementations, Q is an integer in the range [0,1]. Because γ=2^{(-Q)} is also a power of two, modifying the probability model parameter by γ may also be performed using a bit-shift operation.

More generally, the second update parameter modifier may define an update rate gap between the two probability models. The update rate gap refers to a difference in the adaptation speeds of the first probability model and the second probability model. For example, where the first probability model is updated using an update rate of α×β and the second probability model is updated using an update rate of α×β×γ, the update rate gap is determined by the value of γ. A larger value of Q (and hence a smaller value of γ) results in a larger update rate gap, causing the second probability model to adapt more slowly than the first probability model. By controlling the update rate gap, the encoder can tune the multi-hypothesis estimation to balance between fast adaptation and stable estimation for different content characteristics.

At the encoder, the second update parameter modifier may be determined at 906 at a frame level or slice level. The entropy coding may be performed at the slice level to facilitate parallel processing. The second update parameter modifier may be determined using predefined rules based on characteristics of a frame or frame portion, such as the value of the first update parameter modifier. The predefined rules may be established empirically and stored at the encoder. In some implementations, the second update parameter modifier may be specified by a user or external process.

In some implementations, an encoder can determine the second update parameter modifier at 906 using an exhaustive search. The exhaustive search can be performed separately from determining the first update parameter modifier at 902 or can be combined with the exhaustive search for the first update parameter modifier at 902. In some implementations, such as those above describing the grouping of random variables, it is known which random variables will be entropy coded using single hypothesis estimation and which will be entropy coded using multi-hypothesis estimation. An exhaustive search to determine the first update parameter modifier at 902 may be performed using only those random variables to be entropy coded using single hypothesis estimation. Then, those random variables to be entropy coded using multi-hypothesis estimation may use the same value for the first update parameter modifier while determining the second update parameter modifier using an exhaustive search.

An example of this exhaustive technique can assume the first update parameter modifier is the update parameter multiplier β=½. For those random variables being entropy coded using single hypothesis estimation, no further processing is needed. For the other random variables being entropy coded using multi-hypothesis estimation, the probability model is initialized at the start of a slice, and then the random variables are entropy coded according to the coding order of the blocks using some or all possible values for the second update parameter modifier. In the example where the second update parameter modifier is a multiplier γ=2^{(-Q)} as described above, possible values for the second update parameter multiplier γ include 1 (where Q=0) and ½ (where Q=1). Thus, the random variables may be entropy coded using two sets of update parameters for the probability models based on α×βand α×β×γ. The first set is α×½ and α×½ , and the second set is α×½ and α×¼. The resulting bitstream lengths may be compared. The value for the update parameter multiplier γ may be determined as the value that results in the fewest bits.

Another example of an exhaustive technique to determine the second update parameter modifier is to combine the determination at 906 with the determination at 902. In this approach, the random variables are entropy coded using either single or multi-hypothesis estimation using combinations of update parameters based on all available values for the first update parameter modifier and the second update parameter modifier. The first update parameter modifier and the second update parameter modifier are determined as the values that result in the fewest bits for all the encoded variables, whether they are entropy coded using only the first update parameter modifier or using both the first and second update parameter modifiers.

As mentioned above, the step of encoding an identifier of the second update parameter modifier at 908 is dashed in FIG. 9 to show that the step is optional. For example, if an encoder determines the second update parameter modifier at 906 based on predefined rules, and these rules are shared with a decoder, the decoder may apply the same rules to determine the second update parameter modifier without signaling from the encoder.

In other implementations, the encoder may encode an identifier of the second update parameter modifier that was determined at 906. At 908, the identifier may be encoded into a header within the bitstream. The identifier may be an index into a table of available modifiers, or the identifier may be a value from which the second update parameter modifier can be derived. In the example described above, the second update parameter modifier may be a non-integer value. In such implementations, the identifier may be the value of Q where Q is an integer in a defined range. For example, if the range is [0,3], two bits may be used to signal the second update parameter modifier. If the range is [0,1], one bit may be used to signal the second update parameter modifier.

The output parameters determined according to FIG. 9 can be used for updating the probability model(s) at 610. The update functions using the modified update rates are described below with respect to equations (15) and (16).

FIG. 10 is a flow chart of a technique 1000 of determining update parameters for single and multi-hypothesis probability estimation used in entropy decoding. The technique 1000 may be performed as part of entropy decoding a sequence of syntax elements such as the technique 600 as described with respect to FIG. 6 and/or the modification of FIG. 6 to use the selective update of multi-hypothesis probability estimation. More specifically, the identification of the probability model at 604 can include the additional step(s) of determining update parameters.

At 1002, an update parameter modifier is determined. The update parameter modifier may be referred to as a first update parameter modifier because a multi-hypothesis probability estimation may be used for at least some random variables within a frame or a proper subset of blocks of a frame, such as a tile. The update parameter modifier may be determined at 1002 using shared rules between an encoder and the decoder for selecting this value. Alternatively, the update parameter modifier can be determined by decoding an identifier transmitted in the bitstream by the encoder. As described above, the identifier may be the value of the update parameter modifier itself or an index into a list of possible values for the update parameter modifier. In the example described above where the update parameter modifier is the update parameter multiplier β=2^{1-P}, the decoder determines the value of P from the bitstream and determines the update parameter multiplier β using the value of P.

At 1004, a second update parameter modifier is optionally determined. The second update parameter modifier may not be determined where no random variable within a frame or a proper subset of blocks of a frame, such as a tile, is updated in entropy coding using multi-hypothesis probability estimation. In some implementations, even where a frame or frame portion uses only single hypothesis probability estimation, a default value for the second update parameter modifier may be signaled in the bitstream. This provides a consistent header structure across frames or frame portions, which can simplify decoder implementation.

The second update parameter modifier may be determined at 1004 using shared rules between an encoder and the decoder for selecting this value. Alternatively, the second update parameter modifier can be determined by decoding an identifier transmitted in the bitstream by the encoder. As described above, the identifier may be the value of the second update parameter modifier itself or an index into a list of possible values for the second update parameter modifier. In the example described above where the first update parameter modifier is the update parameter multiplier β=2^{1-P}, and the second update parameter modifier is the update parameter multiplier γ=2^{-Q}, the identifier is the value of Q decoded from the bitstream. The second update parameter multiplier γ is determined using the value of Q.

At 1006, the first probability model parameter is modified using the first update parameter modifier. The first probability model parameter controls the update rate of the first probability model and is α in this example. Where the first update parameter modifier is the update parameter multiplier β=2^{1-P}, the modified first probability model parameter is α×β.

At 1008, the second probability model parameter is optionally modified using the second update parameter modifier. The second probability model parameter controls the update rate of the second probability model and is, again, α in this example. Where the second update parameter modifier is the update parameter multiplier γ=2^{-Q}, the modified second probability model parameter is α×β×γ. This operation is optional because the frame or frame portion, in this example a tile, may not have any random variables coded using multi-hypothesis estimation. As mentioned above, even where no random variables are coded using multi-hypothesis estimation, a default second update parameter modifier may be signaled. In this case, the modification at 1008 may occur even where the modified second probability model parameter is not used for updating probabilities in the entropy coding process.

The output parameters determined according to FIGS. 9 and 10 can be used for updating the probability model(s) at 610 at both the encoder and the decoder. In this example, the update functions for the first and second probability models of equations (10) and (11), based on equation (3), are equations (15) and (16), respectively. Equations (15) and (16) are used at both the encoder and the decoder to update the probability models after each symbol is coded.

$${c}_{m 1} ( n ) = \{ \begin{matrix}{a}_{m} ( n - 1 ) \cdot ( 1 - ( α \cdot β ) ) , & \& m < k \\ {a}_{m} ( n - 1 ) + α \cdot β \cdot ( 1 - {a}_{m} ( n - 1 ) ) , & \& m \geq k\end{matrix} \qquad ( 15 )$$

$${c}_{m 2} ( n ) = \{ \begin{matrix}{b}_{m} ( n - 1 ) \cdot ( 1 - ( α \cdot β \cdot γ ) ) , & \& m < k \\ {b}_{m} ( n - 1 ) + α \cdot β \cdot γ \cdot ( 1 - {b}_{m} ( n - 1 ) ) , & \& m \geq k\end{matrix} \qquad ( 16 )$$

The value of the parameter α may be determined according to equation (4), reproduced below.

$$α = 1 / {2}^{3 + I ( count > 15 ) + I ( count > 32 ) + min ( {log}_{2} ( M ) , 2 )}$$

Then, the two probability models may be combined to entropy code the next symbol in a sequence.

The above description of determining update parameters uses a single hypothesis and a dual hypothesis estimation as an example, but the teachings apply to entropy coding using other multi-hypothesis estimations either alone or in combination with single hypothesis estimations.

The techniques described with respect to FIGS. 9 and 10 can eliminate the requirement to store different calculations for every update function at both the encoder and decoder. For example, in the dual hypothesis estimation described above, modification values for equation (4) can be sent such that equations (13) and (14) do not need to be stored.

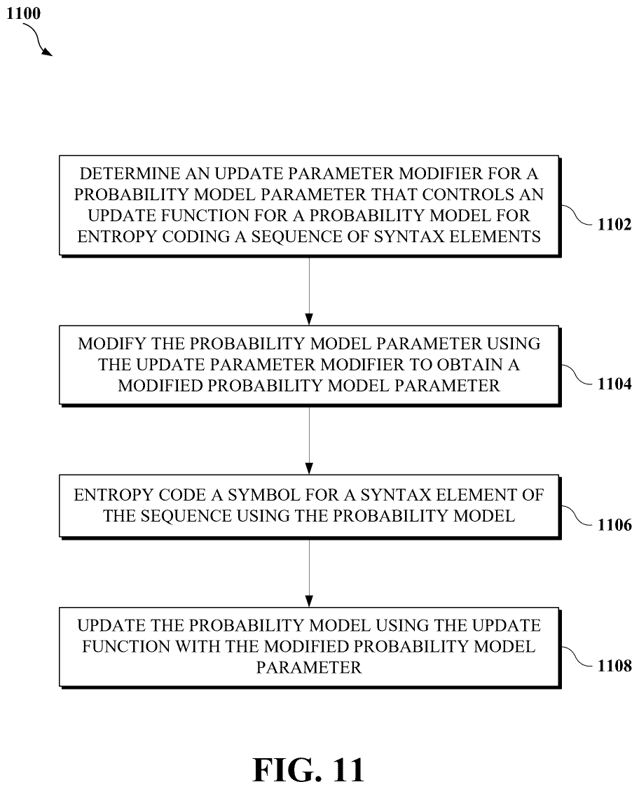

FIG. 11 is a flow chart of a technique 1100 for entropy coding a sequence of syntax elements according to the teachings herein. The technique 1100 may be performed at an entropy coding stage of an encoder, such as the entropy encoding stage 408 of the encoder 400, the entropy coding stage of a decoder, such as the entropy decoding stage 502 of the decoder 500, or the entropy coding stage of both an encoder and a decoder. While the technique 1100 is shown as including steps arranged in a certain sequence, the steps may be performed in a different sequence or be combined. Each step of the technique 1100 may be performed by a processor executing instructions stored in a memory, such as the processor 202 executing instructions stored in the memory 204 of the computing device 200. The technique 1100 provides a framework for determining and applying update parameter modifiers to control how probability models are adapted during entropy coding.

At 1102, an update parameter modifier for a probability model parameter that controls an update function for a probability model for entropy coding the sequence of syntax elements is determined. When implemented by an encoder, the update parameter modifier may be determined based on characteristics of the content being encoded, such as content complexity or motion activity, or may be determined using a search that identifies the modifier resulting in a minimized bitstream size. When implemented by a decoder, the update parameter modifier may be determined by decoding an identifier from a header within the compressed bitstream, where the identifier indicates the modifier selected by the encoder. Alternatively, both the encoder and decoder may use shared predefined rules to determine the update parameter modifier without explicit signaling. In some implementations, the update parameter modifier may include a multiplier applied to a base update rate. For example, the multiplier may be β=2\hat{ }(1−P), where P is an integer identifier in a defined range such as [0, 3]. Determining the update parameter modifier may include decoding the integer identifier P from a header, such as a tile or slice header, within the compressed bitstream.

The base update rate to which the update parameter modifier is applied may be a time-variant update rate that provides a higher adaptation rate at a beginning of use of the probability model as compared to a lower adaptation rate later in use. Such a time-variant update rate allows the probability model to adapt quickly when limited data is available and stabilize as more observations are processed. In some implementations, the time-variant update rate is determined by a count-based function. For example, the base update rate a may be calculated according to a formula that considers the number of symbols coded, such as described with respect to equation (4). The update parameter modifier, such as β, is then applied to this base rate to produce the modified probability model parameter (e.g., α×β). Because the update parameter modifier may be a power of two, the modification may be performed using a bit-shift operation to scale the base update rate rather than a general-purpose multiplication operation.

At 1104, the probability model parameter is modified using the update parameter modifier to obtain a modified probability model parameter. When implemented by an encoder, the modification produces the modified probability model parameter that governs the update rate during encoding of the current frame, tile, or slice. When implemented by a decoder, the same modification is performed using the update parameter modifier determined at 1102 to produce an identical modified probability model parameter, facilitating synchronization between encoder and decoder. In some implementations, the probability model parameter and the update parameter modifier are represented as integer values, and modifying the probability model parameter may include performing a bit-shift operation. For example, where the update parameter modifier is β=2\hat{ }(1−P), the modification α×β can be performed by shifting the integer representation of α by an amount determined by P.

In implementations where a multi-hypothesis probability model is used, the technique 1100 may include determining a second update parameter modifier for a second probability model. When implemented by an encoder, the second update parameter modifier may be determined through a search similar to the first update parameter modifier, or may be based on predefined rules. When implemented by a decoder, the second update parameter modifier may be decoded from a header within the bitstream or determined using shared rules. The second update parameter modifier may define an update rate gap between the first probability model and the second probability model. The update rate gap refers to a difference in the adaptation speeds of the first and second probability models. For example, where the first probability model is updated using α×β and the second probability model is updated using α×β×γ, the update rate gap is determined by γ. A larger update rate gap causes the second probability model to adapt more slowly than the first, allowing the multi-hypothesis estimation to balance between fast adaptation and stable estimation.

At 1106, a symbol for a syntax element of the sequence is entropy coded using the probability model. The sequence of syntax elements may be associated with a random variable of multiple random variables to be coded. In some implementations, the update function used for the probability model is the same for all of the multiple random variables to be coded. The entropy coding may use arithmetic coding, where the probability model provides cumulative probabilities that define intervals for encoding or decoding the symbol. When a multi-hypothesis probability model is used, entropy coding the symbol may use a combination of the first probability model and the second probability model. The combination may include a linear combination, such as a mean, of the first probability model and the second probability model.

At 1108, the probability model is updated using the update function with the modified probability model parameter. The update function adjusts the cumulative probabilities of the probability model based on the observed symbol and the modified probability model parameter. When a single hypothesis probability model is used, the update function is applied with the modified probability model parameter (e.g., α×β) to update the probability model. When a multi-hypothesis probability model is used, the technique 1100 may include updating the first probability model using the update function with a first modified probability model parameter, and updating the second probability model using the update function with a second modified probability model parameter. For example, the first probability model may be updated using α×β, and the second probability model may be updated using α×β×γ. That is, the second modified probability model parameter can be obtained by modifying the probability model parameter using the update parameter modifier and the second update parameter modifier. Both the encoder and decoder perform these updates identically, which maintains synchronization of the probability models throughout the coding process.

In some implementations, updating the probability model at 1108 may include regularizing at least one probability value such that no probability of the probability model is below a defined minimum resolution. Regularizing the first probability model may include applying a weighted average of the first probability model and a first uniform distribution, and regularizing the second probability model may include applying a weighted average of the second probability model and a second uniform distribution. The weighted average adjusts all cumulative probabilities simultaneously to maintain a minimum probability value, correcting the underlying probability model rather than merely clipping values at the arithmetic coder. After updating the probability model at 1108, the technique 1100 may return to 1106 to entropy code a subsequent symbol using the updated probability model.

The technique 1100 may also include determining whether the sequence of syntax elements is entropy coded using a single hypothesis probability model or a multi-hypothesis probability model based on a characteristic associated with the sequence of syntax elements. The characteristic may correspond to properties of a random variable represented by the syntax elements. For example, the characteristic may include a type of the syntax elements (e.g., coefficient values, filter types, intra-coding modes, inter-coding modes, partition modes, or transform modes), a coding channel of the syntax elements (e.g., luma channel or chroma channel), or a coding level of the syntax elements (e.g., sequence level, frame level, or coding block level).

In some implementations, not all types of syntax elements use multi-hypothesis estimation. For example, the multi-hypothesis probability model may be used for only a proper subset of syntax element types, such as filter types, intra-coding modes, and inter-coding modes, while other types, such as coefficient values, use single hypothesis estimation. This selective approach balances coding efficiency gains against increased memory requirements. In some implementations, an encoder and a decoder share at least two preset subsets of syntax element types to be coded, and the technique 1100 may include coding a variable that determines which of the at least two preset subsets is to be used.

For simplicity of explanation, the techniques herein are each depicted and described as a series of blocks, steps, or operations. However, the blocks, steps, or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

In addition to the techniques described with respect to FIGS. 8-11, implementations according to this disclosure may include other techniques for facilitating verification and analysis of automated evaluations.

An aspect of teachings herein includes a compressed bitstream stored on a non-transitory computer-readable medium. The compressed bitstream may include a header portion and a data portion. The header portion may include an identifier for a first update parameter modifier that is used to modify a probability model parameter governing an update function for a probability model. The data portion may include symbols for syntax elements that are entropy coded using the probability model. During decoding, the probability model may be updated after decoding a symbol using the update function with the probability model parameter as modified by the first update parameter modifier.

In some implementations, the header portion may further include a second identifier for a second update parameter modifier. The second update parameter modifier may define an update rate gap between a first probability model and a second probability model used to entropy code the symbol. Additionally or alternatively, the header portion may include a variable that defines a subset of random variables to be coded using a multi-hypothesis probability model as compared to a single-hypothesis probability model. This signaling allows the decoder to determine which syntax element types use multi-hypothesis estimation and to apply the appropriate update parameter modifiers when updating the probability models.

An aspect of the teachings herein includes a technique for entropy coding a sequence of syntax elements that includes receiving the sequence of syntax elements associated with a random variable of multiple random variables to be coded, determining whether the sequence of syntax elements is entropy coded using a single hypothesis probability model or a multi-hypothesis probability model based on the random variable, determining a symbol for a syntax element of the sequence, entropy coding, using arithmetic coding, the symbol using the single hypothesis probability model or the multi-hypothesis probability model determined based on the random variable, and updating the single hypothesis probability model or the multi-hypothesis probability model determined based on the random variable.

In some implementations, a multi-hypothesis probability model is used for only a proper subset of the multiple random variables to be coded.

In some implementations, an encoder and a decoder share at least two preset subsets of the multiple random variables to be coded, each of the at least two preset subsets comprise proper subsets of the multiple random variables to be coded, and the technique includes transmitting, from the encoder to the decoder, a variable that determines which of the at least two preset subsets is to be used for determining whether to use the single hypothesis probability model or the multi-hypothesis probability model.

In some implementations, an encoder and a decoder share at least two preset subsets of the multiple random variables to be coded, each of the at least two preset subsets comprise proper subsets of the multiple random variables to be coded, and the technique includes decoding, from compressed bitstream, a variable that determines which of the at least two preset subsets is to be used for determining whether to use the single hypothesis probability model or the multi-hypothesis probability model.

In any of these techniques, determining whether the sequence of syntax elements is entropy coded using a single hypothesis probability model or a multi-hypothesis probability model based on the random variable can include determining whether the random variable comprises one of coefficient values, filter types, intra-coding modes, inter-coding modes, partition modes, or transform modes.

In any of these techniques, determining whether the sequence of syntax elements is entropy coded using a single hypothesis probability model or a multi-hypothesis probability model based on the random variable can include determining whether the random variable is coded in the luma channel or the chroma channel.

In any of these techniques, determining whether the sequence of syntax elements is entropy coded using a single hypothesis probability model or a multi-hypothesis probability model based on the random variable can include determining whether the random variable is coded at a sequence level, a frame level, or a coding block level.

In some implementations, the multi-hypothesis probability model includes at least a first probability model and a second probability model, and each of the first probability model and the second probability model has different update rates.

In some implementations, entropy coding, using arithmetic coding, the symbol using the multi-hypothesis probability model comprises entropy coding the symbol using a combination of a first probability model and a second probability model, and updating the multi-hypothesis probability model comprises updating the first probability model using a first time-variant update rate to produce a first updated probability model for entropy coding a symbol for a subsequent syntax element of the sequence, and updating the second probability model using a second time-variant update rate to produce a second updated probability model for entropy coding the symbol for the subsequent syntax element of the sequence, wherein the second time-variant update rate is different from the first time-variant update rate.

In a variant of these implementations, the first time-variant update rate provides a first higher adaptation rate at a beginning of use of the first probability model as compared to a first lower adaptation rate later in the use of the first probability model, and the second time-variant update rate provides a second higher adaptation rate at a beginning of use of the second probability model as compared to a second lower adaptation rate later in the use of the second probability model.

In a variant of these implementations, updating the first probability model includes regularizing at least one probability value so no probability of the first updated probability model is below a defined minimum resolution, and updating the second probability model includes regularizing at least one probability value so no probability of the second updated probability model is below the defined minimum resolution.

An aspect of the teachings herein is a technique for entropy coding a sequence of syntax elements that includes receiving the sequence of syntax elements associated with a random variable of multiple random variables to be coded, determining an update parameter modifier for a probability model parameter that controls an update function for a probability model for entropy coding the sequence of syntax elements, wherein the update function is the same for all of the multiple random variables to be coded, updating the probability model parameter using the update parameter modifier, determining a symbol for a syntax element of the sequence, entropy coding, using arithmetic coding, the symbol using the probability model, and updating the probability model using the update function with the probability model parameter as updated.

In some implementations, this technique includes features wherein the probability model is a first probability model, the update parameter modifier is a first update parameter modifier, the random variable is a first random variable, the sequence of syntax elements is a first sequence of syntax parameters, and the technique includes receiving a second sequence of syntax elements associated with a second random variable of multiple random variables to be coded, determining a second update parameter modifier for the probability model parameter that controls the update function for a second probability model for entropy coding the second sequence of syntax elements, determining a symbol for a syntax element of the second sequence, entropy coding, using arithmetic coding, the symbol for the syntax element of the second sequence using the second probability model, updating the second probability model parameter using the second update parameter modifier, and updating the second probability model using a combination of the update function with the first probability model parameter as updated and the update function with the second probability model parameter as updated.

In a variation of these implementations, determining the second update parameter modifier includes decoding an identifier of the second update parameter from a header within a compressed bitstream. The identifier may be a two-bit signal or four-bit signal that defines an update rate gap between the first probability model parameter and the second probability model parameter.

In another variation of these implementations, updating the first probability model includes regularizing at least one probability value so no probability of a first updated probability model is below a defined minimum resolution, and updating the second probability model includes regularizing at least one probability value so no probability of a second updated probability model is below the defined minimum resolution.

In some implementations, the sequence of syntax elements is from a slice of a video frame.

In some implementations, determining the update parameter modifier includes decoding an identifier of the update parameter from a header within a compressed bitstream.

In some implementations, the technique includes determining whether a respective sequence of syntax elements associated with respective random variables of the multiple random variables is entropy coded using a single hypothesis probability model update or a multi-hypothesis probability model update based on the random variable, wherein the sequence of syntax elements is entropy coded using the single hypothesis probability model update.

In a variation of these implementations, the multi-hypothesis probability model update is used for only a proper subset of the multiple random variables to be coded.

In another variation of these implementations, an encoder and a decoder share at least two preset subsets of the multiple random variables to be coded, each of the at least two preset subsets include proper subsets of the multiple random variables to be coded, and the technique includes transmitting, from the encoder to the decoder, a variable that determines which of the at least two preset subsets is to be used for determining whether to use the single hypothesis probability model update or the multi-hypothesis probability model update.

In another variation of these implementations, an encoder and a decoder share at least two preset subsets of the multiple random variables to be coded, each of the at least two preset subsets includes proper subsets of the multiple random variables to be coded, and the technique includes decoding, from compressed bitstream, a variable that determines which of the at least two preset subsets is to be used for determining whether to use the single hypothesis probability model update or the multi-hypothesis probability model update.

In yet another variation of these implementations, determining whether a respective sequence of syntax elements is entropy coded using a single hypothesis probability model update or a multi-hypothesis probability model update includes determining whether the associated random variable comprises one of coefficient values, filter types, intra-coding modes, inter-coding modes, partition modes, or transform modes. Alternatively, or additionally, determining whether a respective sequence of syntax elements is entropy coded using a single hypothesis probability model update or a multi-hypothesis probability model update includes determining whether the random variable is coded in the luma channel or the chroma channel.

Another aspect of the teachings herein is a technique for entropy coding a sequence of syntax elements that includes receiving the sequence of syntax elements associated with a random variable of multiple random variables to be coded, determining a symbol for a syntax element of the sequence, entropy coding, using arithmetic coding, the symbol using a probability model, determining a first update parameter modifier for a probability model parameter that controls an update function for the probability model, wherein the update function is the same for all of the multiple random variables to be coded, updating the probability model parameter using the first update parameter modifier to produce a first probability model parameter, determining a second update parameter modifier for the probability model parameter that controls the update function for the probability model, updating the probability model parameter using the first update parameter modifier and the second update parameter modifier to produce a second probability model parameter, updating the probability model using the update function with the first probability model parameter to determine a first probability model, updating the probability model using the update function with the second probability model parameter to determine a second probability model, and combining the first probability model and the second probability model for entropy coding a subsequent symbol.

In some implementations, the update rate is a time-variant update rate that provides a first higher adaptation rate at a beginning of use of the probability model as compared to a first lower adaptation rate later in the use of the probability model.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of this disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described implementations and other aspects have been described to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law to encompass all such modifications and equivalent arrangements.

What is claimed is:

1. A method for entropy coding a sequence of syntax elements, comprising:
determining an update parameter modifier for a probability model parameter that controls an update function for a probability model for entropy coding the sequence of syntax elements;
modifying the probability model parameter using the update parameter modifier to obtain a modified probability model parameter;
entropy coding a symbol for a syntax element of the sequence using the probability model; and
updating the probability model using the update function with the modified probability model parameter.

2. The method of claim 1, further comprising:
determining whether the sequence of syntax elements is entropy coded using a single hypothesis probability model or a multi-hypothesis probability model based on a characteristic of the sequence of syntax elements.

3. The method of claim 2, wherein the multi-hypothesis probability model is used for only a proper subset of multiple random variables to be coded.

4. The method of claim 2, wherein the characteristic comprises one of a type of the sequence of syntax elements, a coding channel of the sequence of syntax elements, or a coding level of the sequence of syntax elements.

5. The method of claim 2, wherein an encoder and a decoder share at least two preset subsets of random variables to be coded, further comprising:
coding a variable that determines which of the at least two preset subsets is to be used.

6. The method of claim 1, wherein the sequence of syntax elements is associated with a random variable of multiple random variables to be coded.

7. The method of claim 6, wherein the update function is a same for all of the multiple random variables to be coded.

8. A device, comprising:
a processor, the processor configured to execute instructions to:
determine an update parameter modifier for a probability model parameter that controls an update function for a probability model for entropy coding a sequence of syntax elements;
modify the probability model parameter using the update parameter modifier to obtain a modified probability model parameter;
entropy code a symbol for a syntax element of the sequence using the probability model; and
update the probability model using the update function with the modified probability model parameter.

9. The device of claim 8, wherein the update parameter modifier comprises a multiplier applied to a base update rate.

10. The device of claim 9, wherein the base update rate is a time-variant update rate that provides a higher adaptation rate at a beginning of use of the probability model as compared to a lower adaptation rate later in use.

11. The device of claim 10, wherein the time-variant update rate is determined by a count-based function.

12. The device of claim 9, wherein the multiplier is β=2^{(1-P)}, where P is an integer identifier in a defined range.

13. The device of claim 12, wherein, to determine the update parameter modifier, the processor is configured to execute instructions to:
decode the integer identifier from a header within a compressed bitstream.

14. A non-transitory computer-readable storage medium comprising instructions that, when executed by a processor, perform operations for entropy coding a sequence of syntax elements, the operations comprising:
determining an update parameter modifier for a probability model parameter that controls an update function for a probability model for entropy coding the sequence of syntax elements;
modifying the probability model parameter using the update parameter modifier to obtain a modified probability model parameter;
entropy coding a symbol for a syntax element of the sequence using the probability model; and
updating the probability model using the update function with the modified probability model parameter.

15. The non-transitory computer-readable storage medium of claim 14, wherein the probability model is a first probability model and the modified probability model parameter is a first modified probability model parameter, the operations further comprising:
determining a second update parameter modifier for a second probability model;
entropy coding the symbol using a combination of the first probability model and the second probability model;
updating the first probability model using the update function with the first modified probability model parameter; and
updating the second probability model using the update function with a second modified probability model parameter.

16. The non-transitory computer-readable storage medium of claim 15, wherein the second update parameter modifier defines an update rate gap between the first probability model and the second probability model.

17. The non-transitory computer-readable storage medium of claim 15, wherein the combination comprises a linear combination of the first probability model and the second probability model.

18. The non-transitory computer-readable storage medium of claim 15, wherein updating the first probability model includes regularizing at least one probability value such that no probability of the first probability model is below a defined minimum resolution, and wherein updating the second probability model includes regularizing at least one probability value such that no probability of the second probability model is below the defined minimum resolution.

19. The non-transitory computer-readable storage medium of claim 18, wherein regularizing the first probability model comprises applying a weighted average of the first probability model and a first uniform distribution; and wherein regularizing the second probability model comprises applying a weighted average of the second probability model and a second uniform distribution.

20. The non-transitory computer-readable storage medium of claim 14, wherein the probability model parameter and the update parameter modifier are represented as integer values, and wherein modifying the probability model parameter comprises:
performing a bit-shift operation.
